(19) United States
(12) Patent Application Publication
(10) Pub. No.: US 2013/0076318 A1
(43) Pub. Date: Mar. 28, 2013

(54) POWER SUPPLY CONTROL SYSTEM AND METHOD

(71) Applicants: KAI-FU CHEN, Tu-Cheng (TW); CHIA-YUN LEE, Tu-Cheng (TW); CHUANG-WEI TSENG, Tu-Cheng (TW)

(72) Inventors: KAI-FU CHEN, Tu-Cheng (TW); CHIA-YUN LEE, Tu-Cheng (TW); CHUANG-WEI TSENG, Tu-Cheng (TW)

(73) Assignee: HON HAI PRECISION INDUSTRY CO., LTD., Tu-Cheng (TW)

(21) Appl. No.: 13/461,729

(22) Filed: May 1, 2012

(30) Foreign Application Priority Data
Sep. 28, 2011 (TW) 100135110

(51) Int. Cl. G05F 1/46

(52) U.S. Cl. 323/234

(57) ABSTRACT

A power supply control system includes a power supply unit, a timing sequence controller, at least one converting circuit, and a power managing controller. The power supply unit provides a direct current input voltage. The timing sequence controller is powered by the power supply unit. The at least one converting circuit converts the input voltage into a direct current working voltage. The managing controller includes a detection unit detecting a voltage value of the output port, a comparison unit for comparing the voltage value of the output port with a value of the input voltage, and a control unit switching off the power supply unit when the voltage value of the output port is equal to value of the input voltage.

### BACKGROUND

1. Technical Field

The present disclosure relates to a power supply control system and method.

2. Description of Related Art

Electronic devices such as computers usually include a power supply unit (PSU), a timing sequence controller, and a converting circuit. The PSU provides a direct current (DC) input voltage. The timing sequence controller, which is powered by the PSU, is initialized and then generates an enable signal. The converting circuit, when enabled by the enable signal, converts the input voltage into a DC working voltage. However, when the converting circuit short circuits, the input voltage will pass through the converting circuit without conversion and may damage the converting circuit, regardless whether the converting circuit is enabled.

Therefore, it is desirable to provide a power supply control system and method which can overcome the above-mentioned problems.

### BRIEF DESCRIPTION OF THE DRAWINGS

FIG. 1 is a function block diagram of a power supply control system according to an exemplary embodiment.

FIG. 2 is a flowchart of a power supply control method according to an exemplary embodiment.

### DETAILED DESCRIPTION

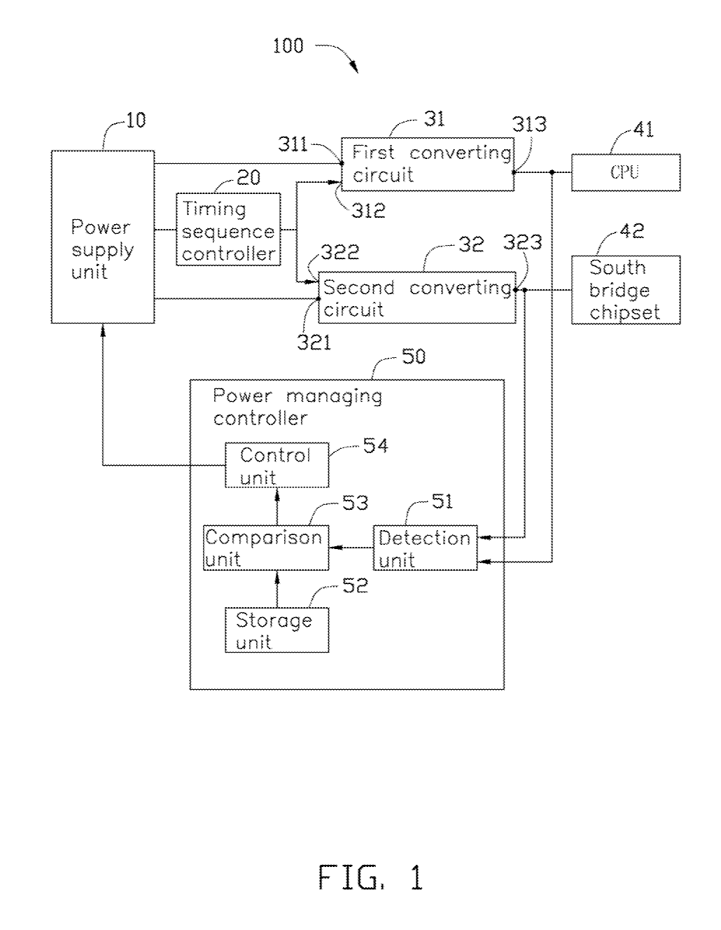

FIG. 1, is a power supply control system 100 for use in an electronic device (not shown), according to an exemplary embodiment. The power supply control system 100 includes a power supply unit (PSU) 10, a timing sequence controller 20, a first converting circuit 31, a second converting circuit 32, a central processing unit (CPU) 41, a south bridge chipset 42, and a power managing controller 50. In one embodiment, the electronic device is a computer.

The PSU 10 converts an AC voltage into a DC input voltage which is suitable for the computer. In one embodiment, the PSU 10 can convert an AC voltage having amplitude of about 220 volts into a DC input voltage of about 12 volts.

The timing sequence controller 20 is electrically connected to the PSU 10 and powered by the PSU 10. When the computer is powered on, the PSU 10 is switched on accordingly and initializes the timing sequence controller 20. The timing sequence controller 20 can be integrated in a base motherboard controller (BMC) of the computer or a separate processor. In this embodiment, the timing sequence controller 20 is integrated in the BMC. Initialization of the timing sequence controller 20 may take about 0.5 seconds to 1 second, which is known as a start time.

The first converting circuit 31 includes a first input port 311, a second input port 312, and a first output port 313. The first input port 311 is electrically connected to the PSU 10 to receive the input voltage. The second input port 312 is electrically connected to the timing sequence controller 20. The first output port 313 is electrically connected to the CPU 41.

The second converting circuit 32 includes a third input port 321, a fourth input port 322, and a second output port 323. The third input port 321 is electrically connected to the PSU 10 to receive the input voltage. The fourth input port 322 is electrically connected to the timing sequence controller 20. The second output port 323 is electrically connected to the south bridge chipset 42.

The power managing controller 50 includes a detection unit 51, a storage unit 52, a comparison unit 53, and a control unit 50. The detection unit 51 is electrically connected to the first output port 313 and the second output port 323 and detects voltage values of the first output port 313 and the second output port 323, respectively. The storage unit 52 is electrically connected to the detection unit 51 and stores values of the input voltage, a first working voltage, and a second working voltage. The comparison unit 53 is electrically connected to the detection unit 51 and the storage unit 52. The control unit 54 is electrically connected to the comparison unit 53 and the PSU 10.

In use, when the computer is turned on, the PSU 10 is switched on accordingly. The PSU 10 initializes the timing sequence controller 20 during the start time. The following three situations will appear:

In a first situation, the first converting circuit 31 and the second converting circuit 32 both work normally. The timing sequence controller 20 generates a first enable signal to enable the first converting circuit 31 after the initialization of the timing sequence controller 20. The first converting circuit 31 is enabled by the first enable signal. The first converting circuit 31 converts the input voltage into the first working voltage and outputs the first working voltage through the first output port 313. The detection unit 51 detects the voltage value of the first output port 313 and transmits the detected voltage value of the first output port 313 to the comparison unit 53. The comparison unit 53 compares the voltage value of the first output port 313 with the values of the input voltage, the first working voltage, and the second working voltage. The comparison unit 53 outputs a first comparison result to the control unit 54 when the voltage value of the first output port 313 is equal to the value of the first working voltage. The control unit 54 keeps the PSU 10 switched on after the control unit 54 receiving the first comparison result.

The first converting circuit 31 feeds back a power good signal to the timing sequence controller 20. The timing sequence controller 20 generates a second enable signal to enable the second converting circuit 32 after the timing sequence controller 20 receiving the power good signal. The second converting circuit 32 is enabled by the second enable signal. The second converting circuit 32 converts the input voltage into the second working voltage and outputs the second working voltage through the second output port 323. The detection unit 51 detects the voltage value of the second output port 323 and transmits the detected voltage value of the second output port 323 to the comparison unit 53. The comparison unit 53 compares the voltage value of the second output port 323 with the values of the input voltage, the first working voltage, and the second working voltage. The comparison unit 53 outputs a second comparison result to the control unit 54 the voltage value of the second output port 323 is equal to the value of the second working voltage. The control unit 54 also keeps the PSU 10 being switched on after the control unit 54 receives the second comparison result. In one embodiment, the first converting circuit 31 and the second converting circuit 32 are both buck converters which are step-down DC to DC converters. The first working voltage and the second working voltage are both lower than the input voltage. The first working voltage is about 1.5 volt and the second working voltage is about 3.3 volt in one example.

In a second situation, the first converting circuit 31 short circuits, the second converting circuit 32 can work normally. The timing sequence controller 20 generates the first enable signal to enable the first converting circuit 31 after the initialization of the timing sequence controller 20. The PSU 10 inputs the input voltage to the first converting circuit 31 during the initialization of the timing sequence controller 20. The first converting circuit 31 directly output the input voltage because the first converting circuit 31 short circuits. In this case, the voltage value of the first output port 313 is equal to the value of the input voltage.

The detection unit 51 detects the voltage value of the first output port 313 and transmits the detected value to the comparison unit 53. The comparison unit 53 compares the voltage value of the first output port 313 with the values of the input voltage, the first working voltage, and the second working voltage. The comparison unit 53 outputs a third comparison result to the control unit 54 when the voltage value of the first output port 313 is equal to the value of the input voltage. The control unit 54 switches off the PSU 10 after the control unit 54 receives the third comparison result. The timing sequence controller 20, the first converting circuit 31, and the second converting circuit 32 are all powered off during the initialization of the timing sequence controller 20.

In a third situation, the first converting circuit 31 works normally while the second converting circuit 32 short circuits. The timing sequence controller 20 generates the first enable signal and transmits the first enable signal to enable the first converting circuit 31 after the initialization of timing sequence controller 20. The PSU 10 inputs the input voltage to the second converting circuit 32 during the initialization of the timing sequence controller 20. The second converting circuit 32 directly outputs the input voltage because the second converting circuit 32 short circuits. In this case, voltage value of the second output 323 is equal to the value of the input voltage.

The detection unit 51 detects the voltage value of the second output port 323 and transmits the detected value to the comparison unit 53. The comparison unit 53 compares the voltage value of the second output port 323 with the values of the input voltage, the first working voltage, and the second working voltage. The comparison unit 53 outputs a fourth comparison result to the control unit 54 when the voltage value of the second output port 323 is equal to the value of input voltage. The control unit 54 switches off the PSU 10 after the control unit 54 receives the fourth comparison result. The timing sequence controller 20, the first converting circuit 31, and the second converting circuit 32 are also all powered off during the initialization of the timing sequence controller 20.

In this embodiment, when each of the first converting circuit 31 and second converting circuit 32 short circuit, the power managing controller 50 will switch off the PSU 10 for protection during the initialization of the timing sequence controller 20.

In this embodiment, when a difference between the voltage value of the first output port 313 and the value of the first working voltage is within 5%, it can be treated that the voltage value of the first output port 313 is equal to the value of the first working voltage. When a difference between the voltage value of the second output port 323 and the value of the second working voltage is within 5%, it can be treated that the voltage value of the second output port 323 is equal to the value of the second working voltage.

In alternative embodiments, the power control system 100 can include one or more than two converting circuits. When any one of the converting circuits short circuits, the power managing controller 50 switches off the PSU 10.

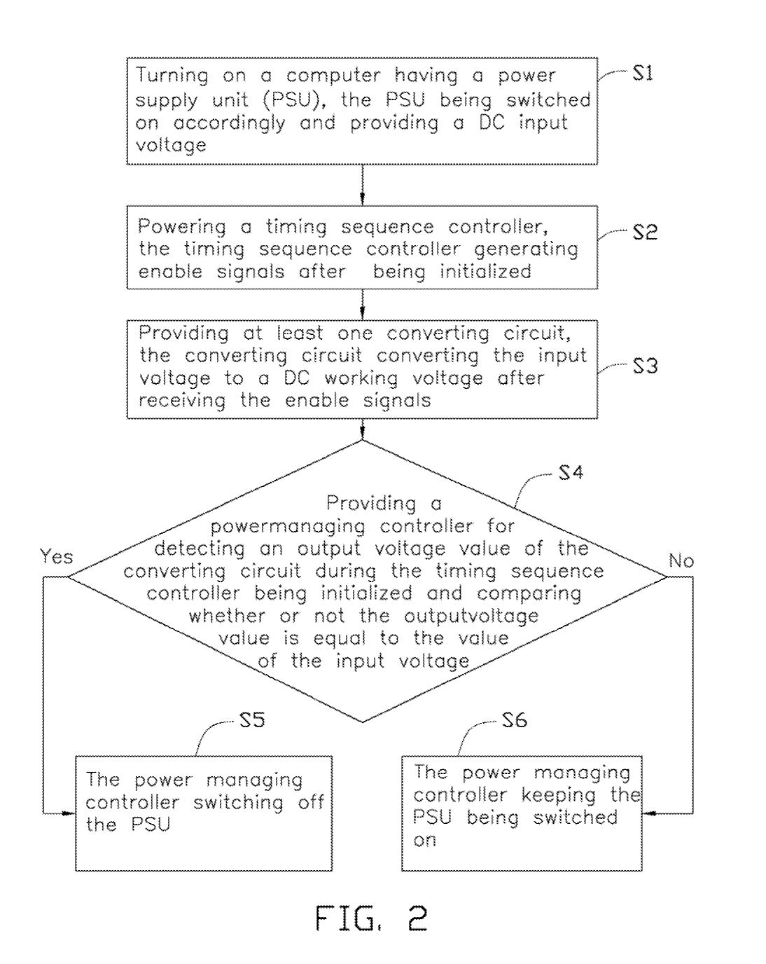

Referring to FIG. 2, a power supply control method, includes the following steps:

In step S1, turning on a computer comprising a power supply unit (PSU), the PSU being switched on accordingly and configured for providing a DC input voltage.

In step S2, powering a timing sequence controller by the PSU, the timing sequence controller generating enable signals after being initialized.

In step S3, providing at least one converting circuit, the converting circuit converting the input voltage into a DC working voltage after being enabled by the enabled signals.

In step S4, providing a power managing controller for detecting an output voltage value of the converting circuit during being initialized and comparing whether or not the output voltage value is equal to the value of the input voltage and keeping the PSU being switched on or switch off the PSU.

In step S5, when the output voltage value is equal to the value of the input voltage, the power managing controller switching off the PSU.

In step S6, when the output voltage value is equal to the value of the working voltage, the power managing controller keeping the PSU switched on.

The above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A power supply control system, comprising:
a power supply unit providing a direct current input voltage;
a timing sequence controller electrically connected to the power supply unit and powered by the power supply unit;
at least one converting circuit electrically connected to the power supply unit and the timing sequence controller, the at least one converting circuit configured to convert the input voltage into a direct current working voltage; and
a power managing controller, comprising:
a detection unit electrically connected to an output port of the at least one converting circuit and configured to detect an voltage value of the output port;
a comparison unit electrically connected to the detection unit and configured to compare the voltage value of the output port with a voltage value of the input voltage; and
a control unit electrically connected to the comparison unit and the power supply unit and configured to control the power supply unit to switch on or switch off;
wherein the control unit switches off the power supply unit when the voltage value of the output port is equal to the value of the input voltage during initialization of the time sequence controller.

2. The power supply control system of claim 1, wherein the power managing controller further comprises a storage unit that stores the value of the input voltage and a value of the working voltage.

3. The power supply control system of claim 2, wherein the control unit keeps the power supply unit being switched on when the voltage value of the output port is equal to the value of the working voltage.

4. The power supply control system of claim 2, wherein when a difference between the voltage value of the output port and the value of the working voltage is within 5%, the voltage value of the output port is treated to be equal to the value of the working voltage.

5. The power supply control system of claim 2, wherein the initialization of the timing sequence controller takes about 0.5 seconds to 1 second.

6. The power supply control system of claim 1, wherein the at least converting circuit is a buck converter, the working voltage is lower than the input voltage.

7. A power supply control method, comprising:
turning on a power supply unit, the power supply unit providing a direct current input voltage after being turned on;
powering a timing sequence controller by the power supply unit, the timing sequence controller generating enable signals after initialization of the timing sequence controller;
providing at least one converting circuit, the at least one converting circuit converting the input voltage into a direct current working voltage after the at least one converting circuit receiving the enable signals;
providing a power managing controller for detecting an output voltage value of the converting circuit during the initialization of the timing sequence controller and comparing whether or not the output voltage value is equal to the value of the input voltage;
when the output voltage value is equal to the value of the input voltage, the power managing controller switch off the PSU during the initialization of the timing sequence controller.

8. The power supply control method of claim 7, wherein further comprises:
when the output voltage value is equal to the value of working voltage, the power managing controller keeps the PSU being switched on.

9. The power supply control method of claim 7, wherein when a difference between the voltage value of the output port and the value of the working voltage is within 5%, the voltage value of the output port is treated to be equal to the value of the working voltage.
